(19) United States
(12) Patent Application Publication
(10) Pub. No.: US 2023/0109079 A1
(43) Pub. Date: Apr. 6, 2023

(54) DATA COLLECTION SYSTEM, DATA COLLECTION METHOD. AND DATA COLLECTION DEVICE

(71) Applicant: TOYOTA JIDOSHA KABUSHIKI KAISHA, Toyota-shi Aichi-ken (JP)

(72) Inventors: Daiki Yokoyama, Gotemba-shi Shizuoka-ken (JP); Akihito Ito, Inazawa-shi Aichi-ken (JP); Ryo Nakabayashi, Susono-shi Shizuoka-ken (JP); Tatsuya Imamura, Okazaki-shi Aichi-ken (JP); Tomohiro Kaneko, Mishima-shi Shizuoka-ken (JP); Hiroki Murata, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/959,840

(22) Filed: Oct. 4, 2022

(30) Foreign Application Priority Data
Oct. 6, 2021 (JP) 2021-164964

(51) Int. Cl. G06N 5/02

(52) U.S. Cl. CPC G06N 5/022

(57) ABSTRACT

A data collection system collects data, for training of a machine learning model for classifying into a plurality of classes, from a data acquisition device to a data collection device. The system includes a processor configured to specify an occurrence probability of occurrence of a low occurrence class for each condition; set a target transmission amount per unit time; specify a current condition; and transmit data from the data acquisition device to the data collection device, in accordance with a target transmission amount corresponding to the specified current condition. The amount of data transmission is larger in a condition having a relatively higher occurrence probability of the low occurrence class, compared to a condition having a relatively lower occurrence probability of occurrence of the low occurrence class.

### CROSS-REFERENCE TO RELATED APPLICATIONS

This application claims priority to Japanese Patent Application No. 2021-164964 filed Oct. 6, 2021, which is incorporated herein by reference in its entirety including the specification, drawings and abstract.

### TECHNICAL FIELD

The present disclosure relates to a data collection system, a data collection method, and a data collection device.

### BACKGROUND

In smart cities, it has been proposed to collect data from multiple entities within the community. In particular, in JP2013-069084A1, since there is uncertainty in data obtained from information systems of different business entities, it has been proposed to collect data obtained by correcting the obtained data in order to solve the uncertainty.

Incidentally, in a smart city or the like, various data are acquired by various data acquisition devices located in the smart city (for example, a surveillance camera, a mobile terminal of a person in the smart city, or the like). In addition, the servers capable of communicating with these data acquisition devices perform various processing on the machine learning model (using or training a machine learning model), based on the acquired data.

In order to perform various processing on such a machine learning model, the server needs to receive data from the data acquisition device. However, when all the data acquired by the data acquisition devices is transmitted to the server and stored in the storage device of the server, a large amount of data is stored in the storage device, thereby requiring a storage device having a very large storage capacity.

In view of the above problems, it is an object of the present disclosure to efficiently collect data from a data acquisition device.

### SUMMARY

(1) A data collection system for collecting data, for training of a machine learning model for classifying into a plurality of classes, from a data acquisition device to a data collection device, the data collection system including a processor,
the processor being configured to:
   specify an occurrence probability of a low occurrence class having a relatively lower occurrence probability compared to other classes of all classes classified by the machine learning model, for each condition when data is acquired by the data acquisition device;
set a target transmission amount per unit time from the data acquisition device to the data collection device, for each condition;
specify a current condition under which data is acquired by the data acquisition device; and
transmit data from the data acquisition device to the data collection device, in accordance with a target transmission amount corresponding to the specified current condition; wherein
the processor sets the target transmission amount such that an amount of data transmission per unit time from the data acquisition device to the data collection device is larger in a condition having a relatively higher occurrence probability of the low occurrence class, compared to a condition having a relatively lower occurrence probability of the low occurrence class.

(2) The data collection system according to above (1), wherein the processor sets the target transmission amount per unit time so that the higher the occurrence probability of the low occurrence class, the greater the amount of data transmission per unit time from the data acquisition device to the data collection device.

(3) The data collection system according to above (1) or (2), wherein
the data collection system collects data for training a plurality of machine learning models having at least partially different input parameters, and
the processor sets the target transmission amount per unit time such that the target transmission amount per unit time is larger, in a condition in which the occurrence probability of a low occurrence class is the same, for a machine learning model related to human health among the machine learning models, compared to for a machine learning model not related to human health.

(4) The data collection system according to any one of above (1) to (3), wherein the processor is configured to specify a low occurrence class having a relatively lower occurrence probability among all classes classified by the machine learning model, as compared with other classes.

(5) The data collection system according to any one of above (1) to (4), wherein the data collection device comprises a processor configured to specify the occurrence probability and set the target transmission amount, and to specify the current condition and transmit the data to the data collection device.

(6) A data collection method for collecting data for training of a machine learning model for classifying into a plurality of classes, from a data acquisition device to a data collection device, the method comprising:
specifying an occurrence probability of a low occurrence class having a relatively lower occurrence probability compared to other classes among all classes classified by the machine learning model, for each condition when data is acquired by the data acquisition device;
setting a target transmission amount per unit time from the data acquisition device to the data collection device for each condition so that an amount of data transmission per unit time from the data acquisition device to the data collection device is larger in a condition where the occurrence probability of the low occurrence class is relatively higher, compared to a condition where the occurrence probability of the low occurrence class is relatively lower;
specifying a current condition under which data is acquired by the data acquisition device; and
transmitting data from the data acquisition device to the data collection device, in accordance with a target transmission amount corresponding to the specified current condition.

(7) A data collection device for collecting data for training of a machine learning model for classifying into a plurality of classes, from a data acquisition device, the data collection device including a processor,
the processor is configured to:
specify an occurrence probability of low occurrence class having a relatively lower occurrence probability compared to other classes of all classes classified by the machine learning model, for each condition when data is acquired by the data acquisition device; and
set a target transmission amount per unit time from the data acquisition device to the data collection device, for each condition, wherein
the processor is configured to set a target transmission amount such that an amount of data transmission per unit time from the data acquisition device is larger in a condition having a relatively higher occurrence probability of the low occurrence class, compared to a condition having a relatively lower occurrence probability of the low occurrence class, and
the processor is configured to transmit the target transmission amount per unit time for each condition set, to the data acquisition device.

### BRIEF DESCRIPTION OF THE DRAWINGS

FIG. 1 is a schematic configuration diagram of a machine learning system.

FIG. 2 is a diagram schematically showing a hardware configuration of a terminal device.

FIG. 3 is a functional block diagram of a processor of the terminal device.

FIG. 4 is a diagram schematically illustrating a hardware configuration of a server.

FIG. 5 is a functional block diagram of the processor of the server.

FIG. 6 is a diagram showing the probability of a user suffering from heat stroke under each condition.

FIG. 7 shows an example of setting the target transmission frequency for each condition.

FIG. 8 is a sequence diagram showing the flow of a training process of the machine learning model.

FIG. 9 is a functional block diagram, similar to FIG. 5, of a processor of a server according to one modification.

FIG. 10 is a diagram showing the occurrence probability of an abnormal person under each condition.

FIG. 11 shows an example of setting the target transmission frequency for each condition.

### DESCRIPTION OF EMBODIMENTS

Hereinafter, embodiments will be described in detail with reference to the drawings. In the following description, similar components are denoted by the same reference numerals.

### First Embodiment

### Configuration of the Machine Learning System

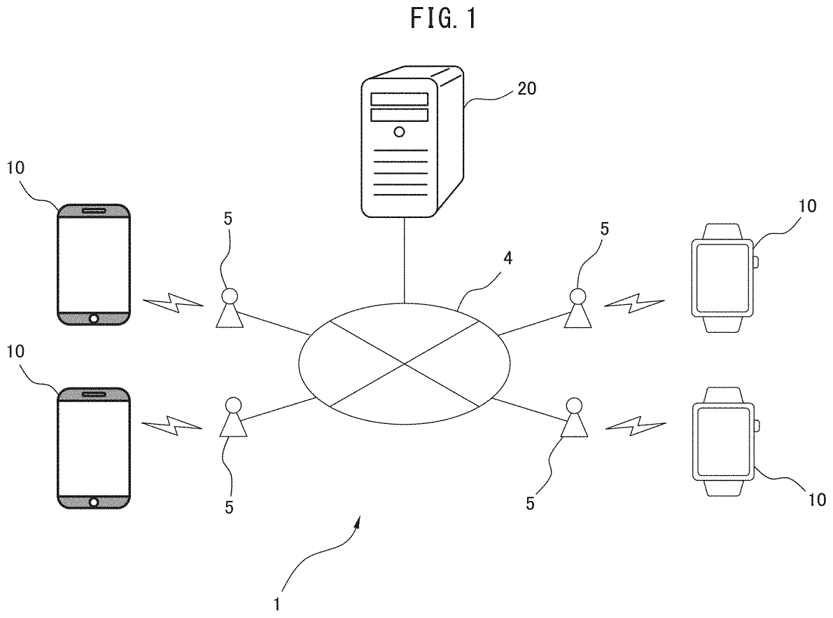

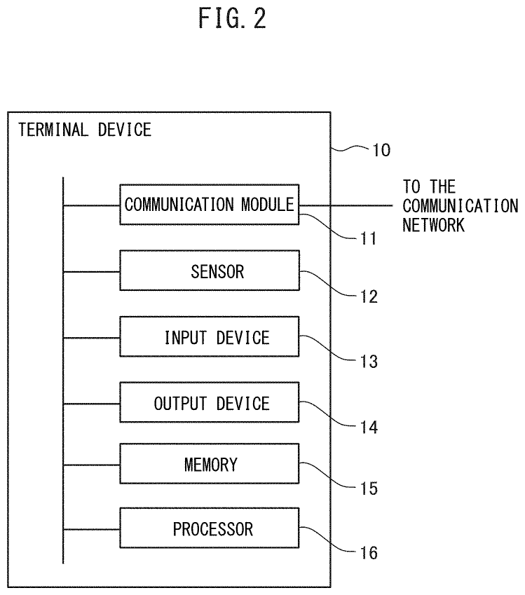

The configuration of a machine learning system 1 according to the first embodiment will be described with reference to FIGS. 1 and 2. FIG. 1 is a schematic configuration diagram of the machine learning system 1. The machine learning system 1 trains a machine learning model used in a server. The machine learning system 1 also functions as a data collection system for collecting data for use and training of the machine learning model.

As shown in FIG. 1, the machine learning system 1 includes a plurality of terminal devices 10, and a server 20 capable of communicating with the terminal devices 10. Each of the plurality of terminal devices 10 and the server 20 are configured to be able to communicate with each other via a communication network 4 configured by an optical communication line or the like and a radio base station 5 connected to the communication network 4 via a gateway (not shown). As the communication protocol between the terminal device 10 and the radio base station 5, various broad-spectrum wireless communication protocols having a long communication distance can be used, for example, communication that conforms to any communication standard such as 4G, LTE, 5G, WiMAX established by 3GPP, or IEEE.

In particular, in the present embodiment, the server 20 communicates with the terminal device 10 located within a predetermined target area. The target area is a range surrounded by predetermined boundaries. For example, it may be a smart city defined as “a sustainable city or region that solves various problems faced by cities and regions and continues to create new value, through the sophistication of management (planning, maintenance, management, operation, etc.) while utilizing new technologies such as ICT (information and communication technology).” The server 20 may be capable of communicating with the terminal device 10 located outside the target area.

The terminal device 10 is an example of a data acquisition device that acquires data for use or training of a machine learning model, which will be described later. In particular, in the present embodiment, the terminal device 10 is a device that is individually held and acquires information of a person holding the terminal device 10. Therefore, in the present embodiment, the terminal device 10 functions as a mobile data acquisition device that acquires information of persons within a predetermined target area. Therefore, in the present embodiment, the terminal device 10 moves along with the movement of the individual holding the terminal device 10. Therefore, when an individual holding the terminal device 10 moves into the target area, the terminal device 10 held by the individual also moves into the target area. Conversely, when an individual holding the terminal device 10 moves out of the target area, the terminal device 10 held by the individual also moves out of the target area.

Specifically, in the present embodiment, the terminal device 10 includes, for example, a wearable terminal such as a watch type terminal (smart watch), a wristband type terminal, a clip type terminal, and an eyeglass type terminal (smart glass), and a mobile terminal. The terminal device acquires information of each person, such as positional information, vital signs (body temperature, heart rate, blood pressure, respiration rate), blood oxygen concentration, blood glucose level, and the like, of each person in the target area.

In the present embodiment, the terminal device 10 includes, in particular, a watch type terminal and a mobile terminal that communicates with the watch type terminal by short-range wireless communication. As the short-range radio communication protocol, for example, communication protocols conforming to any communication standard (for example, Bluetooth (TM) or ZigBee (TM)) established by IEEE, ISO, IEC, or the like may be used.

The terminal device 10 may include a non-movable fixed data acquisition device fixed in the target area. The fixed data acquisition device includes, for example, a device such as a monitor camera for acquiring an image of an arbitrary area in a target area or other information.

FIG. 2 is a diagram schematically showing a hardware configuration of the terminal device 10. As shown in FIG. 2, the terminal device 10 includes a communication module 11, a sensor 12, an input device 13, an output device 14, a memory 15, and a processor 16. The communication module 11, the sensor 12, the input device 13, the output device 14 and the memory 15 are connected to the processor 16 via signal lines.

The communication module 11 is an example of a communication unit that communicates with other devices. The communication module 11 is, for example, a device for communicating with the server 20. In particular, the communication module 11 is a device that communicates with the radio base station 5 through the wide area wireless communication described above, so that the communication module 11 communicates with the server 20 through the radio base station 5 and the communication network 4.

The sensor 12 is an example of a detector that detects various parameters relating to the situation of terminal device 10 and the situation around terminal device 10. In particular, the sensor 12 has a plurality of discrete sensors that detect different parameters. The values of the various parameters detected by the sensor 12 are transmitted to the processor 16 or the memory 15 via signal lines.

Specifically, the sensor 12 includes a GNSS receiver that detects the present position of the terminal device 10. The sensor 12 also includes a sensor for detecting parameters relating to a user holding the terminal device 10. For example, when the terminal device 10 is a watch-type terminal (e.g., a smart watch), the sensor 12 may include a sensor for detecting data (e.g., vital signs such as heart rate, body temperature, blood pressure, and respiration rate, blood oxygen concentration, electrocardiogram, blood glucose level, number of steps, calorie consumption, fatigue, sleep state, etc.) relating to the physical condition of the user wearing the terminal device 10. The sensor 12 may also include a sensor that detects environmental data around the terminal device 10. For example, the terminal device 10 may include a sensor for capturing an image around the terminal device 10 or a sensor for detecting air temperature or humidity around the terminal device 10.

The input device 13 is a device for the user of the terminal device 10 to input information into the terminal device 10. Specifically, the input device 13 includes a touch panel, a microphone, a button, a dial, and the like. Information input via the input device 13 is transmitted to the processor 16 or the memory 15 via a signal line.

The output device 14 is a device for the terminal device 10 to output information. Specifically, the output device 14 includes a display, a speaker, or the like. The output device 14 performs output based on a command transmitted from the processor 16 via a signal line. For example, the display may display an image on the screen based on commands from the processor 16, and/or the speaker may output sounds based on instructions from the processor 16.

The memory 15 includes, for example, a volatile semiconductor memory (e.g., RAM), a nonvolatile semiconductor memory (e.g., ROM), or the like. The memory 15 stores a computer program for executing various processing in the processor 16, various data used when various processing is executed by the processor 16, and the like. The memory 15 stores, for example, a machine learning model, specifically, the configuration of the machine learning model and model parameters such as weights and biases, which will be described later.

The processor 16 includes one or more CPUs (Central Processing Unit) and peripheral circuits thereof. The processor 16 may further comprise an arithmetic circuit, such as a logical arithmetic unit or a numerical arithmetic unit. The processor 16 executes various kinds of processing based on a computer program stored in the memory 15. Specific processing executed by the processor 16 of the terminal device 10 will be described later.

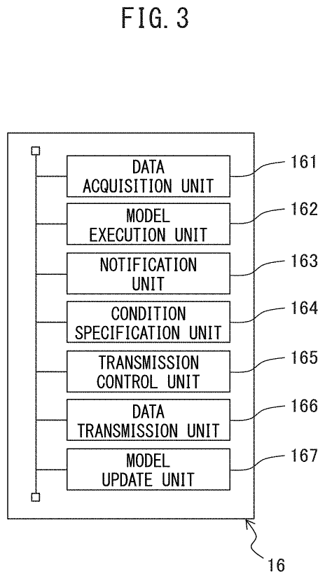

FIG. 3 is a functional block diagram of the processor 16 of the terminal device 10. As shown in FIG. 3, the processor 16 of the terminal device 10 includes a data acquisition unit 161, a model execution unit 162, a notification unit 163, a condition specification unit 164, a transmission control unit 165, a data transmission unit 166, and a model update unit 167. These functional blocks of the processor 16 of the terminal device 10 are functional modules implemented, for example, by a computer program running on the processor 16. Alternatively, the functional blocks included in the processor 16 may be dedicated arithmetic circuits provided in the processor 16. The details of each of these functional blocks will be described later.

The server 20 is connected to a plurality of terminal devices 10 via a communication network 4. In the present embodiment, the server 20 functions as a training device for training a machine learning model used in the terminal device 10. The server 20 also functions as a data collection device that collects data for training the machine learning model from a plurality of terminal devices 10.

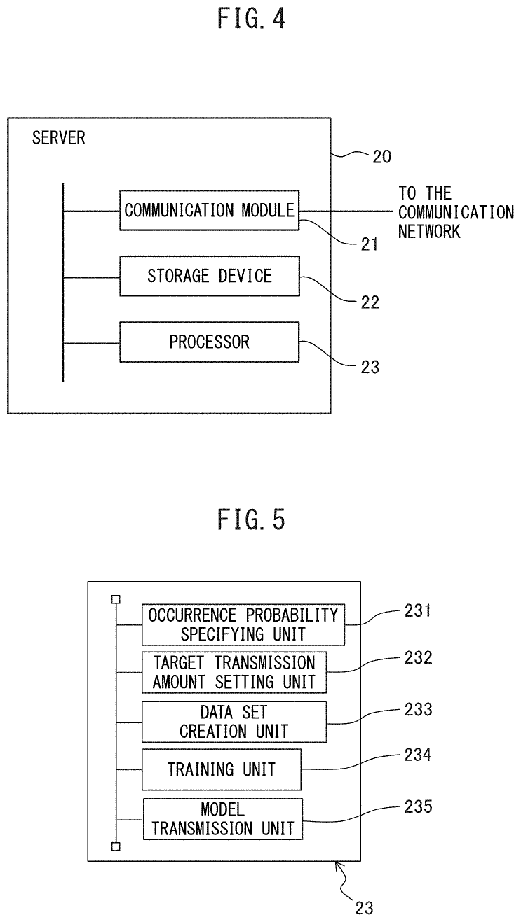

FIG. 4 is a diagram schematically showing a hardware configuration of the server 20. The server 20 includes a communication module 21, a storage device 22, and a processor 23, as illustrated in FIG. 4. The server 20 may include input devices such as a keyboard and a mouse, and output devices such as a display and a speaker.

The communication module 21 is an example of a communication device for communicating with devices outside the server 20. The communication module 21 comprises an interface circuit for connecting the server 20 to the communication network 4. The communication module 21 is configured to be able to communicate with each of the plurality of terminal devices 10 via the communication network 4 and the radio base station 5.

The storage device 22 is an example of a storage device for storing data. The storage device 22 includes, for example, a hard disk drive (HDD), a solid state drive (SSD), or an optical recording medium. The storage device 22 may include a volatile semiconductor memory (e.g., RAM), a nonvolatile semiconductor memory (e.g., ROM), or the like. The storage device 22 stores a computer program for executing various processing by the processor 23 and various data used when various processing is executed by the processor 23. In particular, the storage device 22 stores data received from the terminal device 10 and data used for training the machine learning model.

The processor 23 has one or a plurality of CPUs and peripheral circuits thereof. The processor 23 may further comprise an arithmetic circuit such as a GPU or a logical or numerical unit. The processor 23 executes various kinds of processing based on a computer program stored in the storage device 22. Specific processing executed by the processor 23 of the server 20 will be described later.

FIG. 5 is a functional block diagram of the processor 23 of the server 20. As shown in FIG. 5, the processor 23 includes an occurrence probability specifying unit 231, a target transmission amount setting unit 232, a data set creation unit 233, a training unit 234, and a model transmission unit 235. These functional blocks of the processor 23 of the server 20 are, for example, functional modules implemented by computer programs running on the processor 23. Alternatively, the functional blocks included in the processor 23 may be dedicated arithmetic circuits provided in the processor 23.

### Machine Learning Model

In the present embodiment, when a predetermined process is performed in the terminal device 10, a machine learning model subjected to machine learning is used. In the present embodiment, the machine learning model is a model for performing classification to a plurality of classes based on data acquired from the sensor 12 of the terminal device 10. Hereinafter, a machine learning model which estimates whether or not a person holding the terminal device 10 suffers from heat stroke (i.e., classifying a class representing that the person suffers from heat stroke and a class representing that the person does not suffer from heat stroke), based on data acquired from the sensor 12 of the terminal device 10, will be described as an example.

Specifically, in the present embodiment, data relating to the state of the user's body such as vital signs, blood oxygen concentration, and electrocardiogram of the user holding the terminal device 10, and environmental data such as air temperature and humidity around the terminal device 10 are input as input parameters to the machine learning model. Data relating to the body of the user holding the terminal device 10 and environment data are acquired from the sensor 12 of the terminal device 10. Alternatively, the environmental data may be obtained from the server 20 via the communication module 11 rather than from the sensor 12. When input parameters are input to the machine learning model, the machine learning model outputs whether or not the user holding the terminal device 10 suffers from heat stroke.

Various machine learning algorithms can be used in the machine learning model. In the present embodiment, the machine learning model is a model trained by supervised learning, such as a neural network (NN), a support vector machine (SVM), and a decision tree (DT). In particular, in the present embodiment, the machine learning model may be a recurrent neural network (RNN) model in which data relating to the state of the user's body and environment data are input as input parameters in time series.

As the machine learning model, a model having various input parameters and output parameters can be used. The input parameters include various parameters that can be detected by the sensor 12 of the terminal device 10. Specifically, in the present embodiment, the input parameters include, for example, vital signs (heart rate, body temperature, blood pressure, and respiration rate), blood oxygen concentration, electrocardiogram, blood glucose level, number of steps, calorie consumption, fatigue, sleep state, time, image, moving image, and the like. The input parameters may include parameters transmitted from the server 20 via the communication network 4 (for example, the temperature, humidity, weather, wind speed, and the like around the terminal device 10). In addition, the output parameters include various parameters relating to the body of the user. Specifically, an output parameter may include, for example, the probability that the person holding the terminal device 10 will experience hypothermia.

In the present embodiment, the training of the machine learning model as described above is performed not by the terminal device 10 but by the server 20. The machine learning model is trained using a training data set. The training data set includes data used as input parameters and values of output parameters corresponding to the data (such as ground truth values or ground truth labels). In particular, in the present embodiment, the training data set includes time-series data acquired by the terminal device 10 for a certain subject and data on whether the subject suffers from heat stroke. For example, in the case where whether or not the person suffers from heat stroke is the output parameter as described above, the value of the class representing that the person suffers from heat stroke among the output parameters is set to 1 in the training data set created for the person suffering from heat stroke. On the other hand, in the training data set created for the person who does not suffer from heat stroke, the value of the class representing that the person does not suffer from heat stroke among the output parameters is set to 1. The training data set may be generated by performing preprocessing (processing for missing data, normalization, standardization, etc.) on the output value of the sensor 12.

In training the machine learning model, for example, any known technique (e.g., an error back propagation method) may be used to repeatedly update the model parameters in the machine learning model (i.e., parameters whose values are updated by training, such as weights w and biases b of NN). The model parameters are repeatedly updated so that, for example, the difference between the output value of the machine learning model and the ground truth value of the output parameter included in the training data set becomes small. As a result, the machine learning model is trained, and a trained machine learning model is generated.

### Use of Machine Learning Models

Next, processing using the machine learning model in the terminal device 10 will be described with reference to FIG. 3. In the present embodiment, the terminal device 10 estimates whether or not the user holding the terminal device 10 suffers from heat stroke, based on the values of the various parameters detected by the sensor 12 of the terminal device 10. In addition, the terminal device 10 notifies the user that there is a risk of heat stroke when it is determined that heat stroke is likely. The processor 16 of the terminal device 10 estimates whether or not the user suffers from heat stroke using the data acquisition unit 161, the model execution unit 162, and the notification unit 163.

The data acquisition unit 161 acquires data including data relating to input parameters of the machine learning model. Specifically, the data acquisition unit 161 acquires the values of the input parameters detected by the sensor 12 of the terminal device 10. In the present embodiment, the data acquisition unit 161 acquires the body temperature, the heart rate, the blood pressure, the respiration rate, and the like of the user from the sensor 12. The data acquisition unit 161 may acquire the values of the input parameters from an external device such as the server 20 via the communication module 11. In the present embodiment, the server 20, when receiving the current position detected by the sensor 12 of each terminal device 10, transmits the current temperature and the current humidity around the position to the terminal device 10. Therefore, the data acquisition unit 161 acquires the temperature and humidity around the terminal device 10 from the server 20. The data acquisition unit 161 stores the acquired data in the memory 15.

When the data acquisition unit 161 acquires the current values of the input parameters of the machine learning model, the model execution unit 162 inputs the acquired values of the input parameters to the machine learning model, and calculates the value of the output parameter. In the present embodiment, in the model execution unit 162, when the data relating to the body of the user and the environment data acquired by the data acquisition unit 161 are input to the machine learning model, whether or not the user suffers from heat stroke is output.

Here, the program for executing the machine learning model and the values of the model parameters used in the machine learning model are stored in the memory 15. Therefore, the model execution unit 162 calculates the value of the output parameter using the values of the program and the model parameters stored in the memory 15.

The notification unit 163 notifies the user based on the value of the output parameter calculated by the model execution unit 162. The notification unit 163 notifies the user via the output device 14. Specifically, in the present embodiment, when the model execution unit 162 determines that the user suffers from heat stroke, the notification unit 163 notifies the user via the output device 14. In this case, for example, the notification unit 163 may display a warning regarding heat stroke on the display, or may generate a warning sound regarding heat stroke from a speaker.

### Training of Machine Learning Models

Next, the training process of the machine learning model used in the model execution unit 162 of each terminal device 10 will be described with reference to FIGS. 3 and 5 to 8. In the present embodiment, the training of the machine learning model is performed in the server 20. Specifically, the terminal device 10 transmits the training data acquired in the terminal device 10 to the server 20. The server 20 trains the machine learning model by using the received training data, and transmits the trained machine learning model to the terminal device 10. Then, the terminal device 10 updates the machine learning model to the transmitted trained model.

Meanwhile, when the machine learning model is trained, data acquired by the terminal device 10 is transmitted to the server 20. However, when all of the data acquired by the terminal device 10 is transmitted to the server 20 and stored in the storage device 22 of the server 20, a large amount of data is stored in the storage device 22. Therefore, a storage device 22 with very large storage capacity is required.

On the other hand, the occurrence probability of only a part of the classes classified by the machine learning model may be extremely low. For example, a user holding each terminal device 10 has a low probability of suffering from heat stroke. For this reason, in the machine learning model which estimates whether or not the user suffers from heat stroke on the basis of the data acquired from the terminal device 10, the occurrence probability of the class indicating that the user suffers from heat stroke is very low. Hereinafter, a class having a relatively low occurrence probability compared to other classes among all classes classified by the machine learning model is also referred to as a low occurrence class.

In such a case, if all the data acquired by the terminal device 10 is used in training the machine learning model, data of a class having a high occurrence probability is excessive. When data of a class having a high occurrence probability is excessive, data of a low occurrence class having a low occurrence probability is relatively extremely small, and therefore, it is not always possible to create a machine learning model having a high estimation accuracy. For this reason, the data of the class having a high occurrence probability, that is, the data in the case where the user does not suffer from heat stroke, need not necessarily be used entirely.

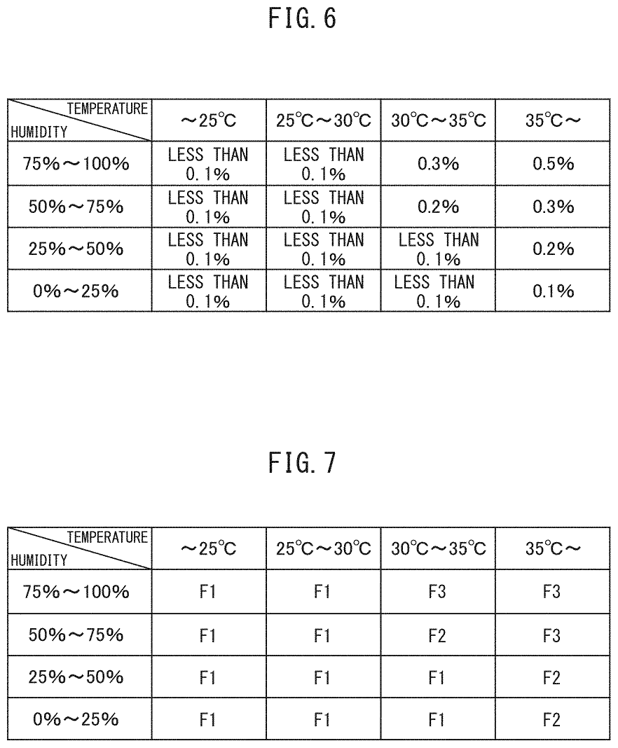

FIG. 6 is a diagram showing the probability of a user suffering from heat stroke under each condition. In particular, FIG. 6 shows the probability of a user suffering from heat stroke for each condition defined by temperature and humidity. As shown in FIG. 6, the higher the temperature and the higher the humidity, the higher the probability of the user suffering from heat stroke. On the other hand, when the temperature is low or the humidity is low, the probability of the user suffering from heat stroke is low. Note that the probability of a user suffering from heat stroke is generally low. Thus, the class representing the user suffering from heat stroke can be said to be a low occurrence class with a relatively low occurrence probability. On the other hand, the class indicating that the user does not suffer from heat stroke can be said to be a class having a relatively high occurrence probability.

Therefore, in the present embodiment, in the server 20, the transmission frequency of transmitting the data acquired by the terminal device 10 to the server 20 is set based on the occurrence probability of the low occurrence class. Under the condition that the occurrence probability of the low occurrence class is relatively high, the frequency of transmission of the data acquired by the terminal device 10 to the server 20 is set higher. Therefore, in a condition in which the probability of the user suffering from heat stroke is high, for example, in the example of FIG. 6, in a condition in which the temperature and the humidity are high, the frequency of transmission of the data acquired by the terminal device 10 to the server 20 is set higher. On the other hand, under the condition that the occurrence probability of the low occurrence class is relatively low, the frequency of transmission of the data acquired by the terminal device 10 to the server 20 is set lower. Therefore, in a condition in which the probability of the user suffering from heat stroke is low, for example, in the example of FIG. 6, in a condition in which the temperature and the humidity are low, the frequency of transmission of the data acquired by the terminal device 10 to the server 20 is set lower.

FIG. 7 is an example of setting the target transmission frequency for each condition when the occurrence probability of the low occurrence class in each condition is the probability shown in FIG. 6. In the example shown in FIG. 7, the data acquired by the terminal device 10 is transmitted to the server 20 at three different transmission frequencies, based on the occurrence probability of the low occurrence class. In particular, in the example shown in FIG. 7, the target transmission frequency is set to F1 under the condition that the probability of the user suffering from heat stroke is less than 0.1%. Also, in a condition where the probability of the user suffering from heat stroke is 0.1% or greater and less than 0.3%, the target transmission frequency is set to F2 which is higher than F1. In addition, in a condition where the probability of the user suffering from heat stroke is 0.3% or more, the target transmission frequency is set to F3 which is higher than F2.

As described above, in the present embodiment, in the condition where the occurrence probability of the low occurrence class is relatively high, the target transmission frequency from the terminal device 10 to the server 20 is relatively higher, as compared with the condition where the occurrence probability of the low occurrence class is relatively lower. That is, in such a condition, the amount of data transmitted per unit time from the terminal device 10 to the server 20 is large. As a result, it is possible to reduce data transmission of a class having a high occurrence probability while suppressing reduction in data transmission of a low occurrence class having a low occurrence probability. As a result, it is possible to suppress the amount of data stored in the storage device 22 while suppressing the deterioration of the estimation accuracy of the machine learning model, and therefore, it is possible to efficiently collect data from the terminal device 10.

Next, the training process of the machine learning model will be described in detail with reference to FIGS. 3, 5, and 8.

The processor 16 of the terminal device 10 uses the data acquisition unit 161, the condition specification unit 164, the transmission control unit 165, the data transmission unit 166, and the model update unit 167 to train the machine learning model (see FIG. 3). In addition, the processor 23 of the server 20 uses the occurrence probability specifying unit 231, the target transmission amount setting unit 232, the data set creation unit 233, the training unit 234, and the model transmission unit 235 to train the machine learning model (see FIG. 5).

The condition specification unit 164 of the terminal device 10 specifies the current condition under which the data is acquired by the data acquisition unit 161 of the terminal device 10. As described above, in the present embodiment, the target transmission frequency from the terminal device 10 to the server 20 is set for each condition, but the condition specification unit 164 specifies which of these conditions corresponds to the current condition. In particular, in the present embodiment, the condition specification unit 164 specifies a condition among the plurality of conditions shown in FIG. 7, which corresponds to the condition determined by the air temperature and the humidity. Therefore, in the present embodiment, the current conditions are identified based on the current air temperature and humidity acquired by the data acquisition unit 161.

The transmission control unit 165 of the terminal device 10 controls the transmission of data from the terminal device 10 to the server 20. The transmission control unit 165 controls, for example, the frequency of data transmission from the terminal device 10. In other words, the transmission control unit 165 controls the ratio of the data to be transmitted to the server 20 among the data acquired by the terminal device 10. Therefore, when the data transmission frequency is controlled to be high, for example, all the data acquired by the terminal device 10 (all the data used for the machine learning model) is transmitted to the server 20. On the other hand, when the data transmission frequency is controlled to be low, part of the data acquired by the terminal device 10 (some of the data used in the machine learning model) is transmitted to the server 20.

In particular, in the present embodiment, as will be described later, the target transmission frequency is set for each condition in the target transmission amount setting unit 232. Therefore, the transmission control unit 165 includes a current condition specified by the condition specification unit 164, based on the relationship between each condition and the target transmission frequency set in the target transmission amount setting unit 232, to set the target transmission frequency corresponding to the current condition. Then, the transmission control unit 165 causes the terminal device 10 to transmit data to the server 20 in accordance with the target transmission frequency calculated in this manner.

The data transmission unit 166 of the terminal device 10 transmits the data acquired from the sensor 12 of the terminal device 10 by the data acquisition unit 161 to the server 20 via the communication network 4. The data transmitted to the server 20 includes the values of the input parameters of the machine learning model, since the data is used to train the machine learning model. When the value of the output parameter is detected by the sensor 12 of the terminal device 10 (for example, when the machine learning model is a model that estimates the future value of the output parameter from the values of the input parameters), the data transmitted to the server 20 may include the value of the output parameter.

In particular, in the present embodiment, the data transmission unit 166 transmits data to the server 20 in accordance with a command from the transmission control unit 165. Therefore, the data transmission unit 166 transmits data to the server 20 in accordance with the target transmission frequency set by the transmission control unit 165.

As described above, the model update unit 167 of the terminal device 10 updates the machine learning model used by the model execution unit 162 stored in the memory 15 to the machine learning model transmitted by the model transmission unit 235.

The occurrence probability specifying unit 231 of the server 20 specifies the occurrence probability of the low occurrence class for each of various conditions in which data is acquired by the terminal device 10 (in the present embodiment, for each condition determined by the air temperature and humidity). The occurrence probability of the low occurrence class for each condition is specified based on the occurrence information of the low occurrence class. In the present embodiment, the probability of the user suffering from heat stroke under each condition is specified based on the number of users in the target area under each condition and the heat stroke suffering information of the users suffering from heat stroke among the users.

The number of users in the target area under each condition is specified based on the number of terminal devices 10 located in the target area under each condition. The number of terminal devices 10 located in the target area is specified, for example, by counting the number of terminal devices 10 that transmitted position information indicating that the terminal device 10 communicating with the server 20 is located in the target area.

The heat stroke suffering information of each user is transmitted, for example, from each terminal device 10. Specifically, when the user suffers from heat stroke, the information is input to the terminal device 10 by the user himself/herself via the input device 13. The heat stroke suffering information input to the terminal device 10 is transmitted to the server 20 via the communication network 4 together with the temperature and humidity at that time (parameters representing conditions at the time of suffering).

Alternatively, the user's heat stroke suffering information is transmitted from, for example, a terminal device (not shown) disposed in a medical institution or the like. More specifically, when the user suffers from heat stroke, the information of the user suffering from heat stroke is input to the terminal device by the medical institution that has diagnosed the user. The information on the occurrence of heat stroke input in the terminal device of the medical institution is transmitted to the server 20 via the communication network 4. In addition, the server 20 acquires temperature and humidity (parameters representing conditions at the time of suffering) when the user suffers from heat stroke based on data transmitted in the past from the terminal device 10 held by the user.

The target transmission amount setting unit 232 of the server 20 sets the target transmission frequency from the terminal device 10 to the server 20 for each condition under which data is acquired in the terminal device 10 (that is, for each condition determined by the air temperature and the humidity). In the present embodiment, the target transmission amount setting unit 232 sets the target transmission frequency so that the target transmission frequency becomes higher as the occurrence probability of the low occurrence class in each condition becomes higher. In particular, in the present embodiment, as shown in FIG. 7, the target transmission amount setting unit 232 sets the target transmission frequency in three stages of F1, F2, and F3 in accordance with the probability that the user suffers from heat stroke under each condition. In the present embodiment, the server 20 transmits the set target transmission frequency for each condition to the terminal device 10.

Note that the target transmission amount setting unit 232 may set the target transmission frequency in two stages in accordance with the probability of the user suffering from heat stroke under each condition. In this case, for example, the target transmission frequency is set relatively lower under the condition that the probability of suffering from heat stroke is less than 0.1%, and the target transmission frequency is set relatively higher under the condition that the probability of suffering from heat stroke is 0.1% or more. Alternatively, the target transmission amount setting unit 232 may set the target transmission frequency in multiple stages of four or more or continuously in accordance with the probability of the user suffering from heat stroke in each condition. In any case, in the present embodiment, the target transmission amount setting unit 232 sets the target transmission frequency for each condition so that the target transmission frequency of data per unit time from the terminal device 10 to the server 20 is higher in the condition where the occurrence probability of the low occurrence class is relatively higher than in the condition where the occurrence probability of the low occurrence class is relatively lower.

The data set creation unit 233 of the server 20 creates a training data set used for training the machine learning model. The training data set includes measured values of input parameters of the machine learning model and ground truth values or ground truth labels of output parameters. For example, in the present embodiment, the training data set includes time-series data acquired by the terminal device 10 of a certain user, and heat stroke suffering information (ground truth label) of heat stroke of the user.

The time series data acquired by each user's terminal device 10 is transmitted from each terminal device 10 to the server 20 by the data transmission unit 166. When creating the training data set, the data set creation unit 233 uses the data transmitted from each terminal device 10 in this manner. In creating the training data set, the data set creation unit 233 uses the heat stroke suffering information transmitted from the terminal device 10 or the terminal device of the medical institution as described above.

The training unit 234 of the server 20 uses the training data set to train the machine learning model by a technique such as the error back propagation method as described above. Specifically, the training unit 234 updates the values of the model parameters of the machine learning model using the training data set.

The model transmission unit 235 of the server 20 transmits the trained machine learning model subjected to the machine learning by the training unit 234 to each terminal device 10 via the communication network 4. Specifically, the value of the model parameters updated by the training performed by the training unit 234 is transmitted to each terminal device 10.

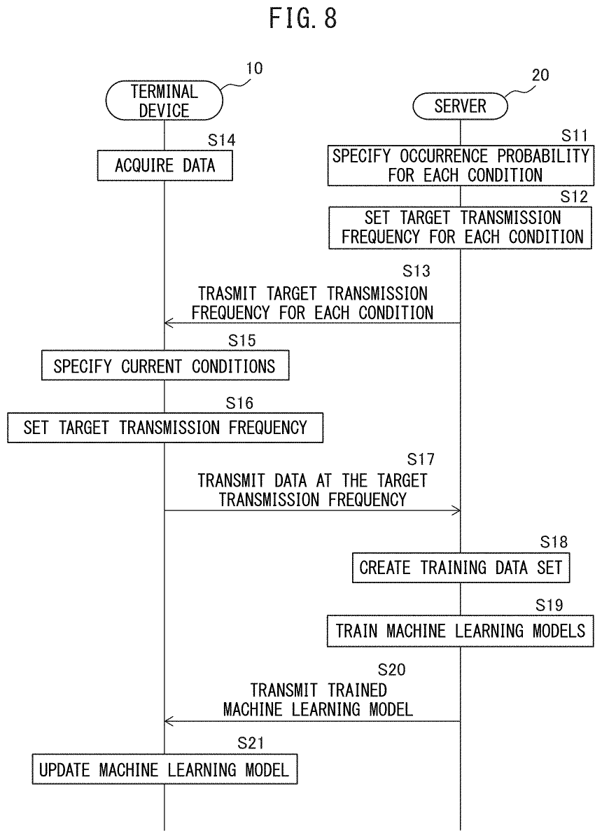

FIG. 8 is a sequence diagram showing the flow of the training process of the machine learning model. The training process illustrated in FIG. 8 is performed in the processor 16 of the terminal device 10 and the processor 23 of the server 20.

In the training process according to the present embodiment, as shown in FIG. 8, first, the occurrence probability specifying unit 231 of the server 20 specifies the occurrence probability of the low occurrence class (the class indicating that a patient suffers from heat stroke) for each condition (in particular, for each condition determined by temperature and humidity) (Step S11). As described above, the occurrence probability specifying unit 231 specifies the occurrence probability, based on the data transmitted from the terminal device 10 in the past and the past heat stroke suffering information. The data transmitted from the terminal device 10 in the past and the past heat stroke suffering information are stored in the storage device 22 of the server 20. Therefore, the occurrence probability specifying unit 231 specifies the occurrence probability for each condition, based on the data and information stored in the storage device 22. In the present embodiment, the occurrence probability of each condition in step S11 is specified every predetermined time interval or every time a predetermined amount of data is stored in the storage device 22.

Next, the target transmission amount setting unit 232 of the server 20 sets the target transmission frequency for each condition, based on the occurrence probability for each condition specified in step S11 (Step S12). As described above, in the present embodiment, the target transmission amount setting unit 232 sets the target transmission frequency such that the higher the occurrence probability of the low occurrence class, the higher the target transmission frequency in that condition. In the present embodiment, the target transmission frequency in step S12 is set every time the occurrence probability for each condition is specified in step S11.

When the target transmission frequency for each condition is set in step S12, the target transmission amount setting unit 232 transmits the target transmission frequency for each condition to the terminal device 10 (Step S13). Specifically, the target transmission amount setting unit 232 transmits information relating to the relationship between each condition and the target transmission frequency (e.g., the relationship shown in FIG. 7) to the terminal devices 10. In particular, in the present embodiment, the target transmission amount setting unit 232 transmits the data to the terminal devices 10 located within the target area. Therefore, when the target transmission frequency is set in step S12, the target transmission amount setting unit 232 transmits information on the relationship between each condition and the target transmission frequency to the terminal devices 10 located in the target area. In addition, the target transmission amount setting unit 232 also transmits information on the relationship between each condition and the target transmission frequency to the terminal device 10 that has entered the target area after the target transmission frequency is set in step S12.

On the other hand, the data acquisition unit 161 of each terminal device 10 periodically acquires various data from the sensor 12 or the server 20 (Step S14). In the present embodiment, the data acquisition unit 161 acquires data relating to the input parameters of the machine learning model, and data for specifying the current condition (in the present embodiment, air temperature and humidity).

When the data is acquired by the data acquisition unit 161, the condition specification unit 164 specifies the current condition under which the data is acquired by the data acquisition unit 161 of the terminal device 10 (Step S15). In the present embodiment, based on the data acquired in step S14, the data acquisition unit 161 specifies the current condition among the conditions shown in FIG. 7.

When the current condition is specified in step S15, the transmission control unit 165 calculates the target transmission frequency (step S16). The transmission control unit 165 sets the target transmission frequency for the terminal device 10, based on the information on the relationship between each condition and the target transmission frequency transmitted in step S13 and the current condition specified in step S15.

When the target transmission frequency is set in this manner, the data transmission unit 166 transmits data to the server 20 at the set target transmission frequency (Step S17). In particular, the data transmission unit 166 transmits data used for the machine learning model among the data acquired by the data acquisition unit 161. The data transmitted to the server 20 is stored in the storage device 22 of the server 20.

When the data transmitted by the data transmission unit 166 is stored in the storage device 22, the data set creation unit 233 of the server 20 creates a training data set (Step S18). The data set creation unit 233 creates the training data set using data stored in the storage device 22 as input parameters. In addition, the data set creation unit 233 creates a training data set by using the heat stroke suffering information input to the terminal device 10 by the user himself/herself or the heat stroke suffering information input to the terminal device of the medical institution as the ground truth value of the output parameter.

When the number of training data sets necessary for training is created by the data set creation unit 233 in step S18, the training unit 234 uses the created data set to train the machine learning model (Step S19). The training of the machine learning model is performed by a known method such as the error back propagation method as described above.

When the training of the machine learning model by the training unit 234 is completed, the model transmission unit 235 transmits the trained machine learning model to the terminal device 10 (Step S20). Upon receiving the trained machine learning model, the model update unit 167 of the terminal device 10 updates the machine learning model used by the model execution unit 162 to the machine learning model transmitted from the server 20 (Step S21).

### Advantageous Effects and Modifications

According to the present embodiment, when the condition that the occurrence probability of the low occurrence class is high is satisfied, the data is transmitted from the terminal device 10 to the server 20 at a high frequency. On the other hand, when the condition that the occurrence probability of the low occurrence class is high is not satisfied, the data is transmitted from the terminal device 10 to the server 20 at a low frequency. Therefore, data for learning with high accuracy is transmitted to the server 20 with high frequency. On the other hand, data which is not so necessary for learning with high accuracy is transmitted to the server 20 at a low frequency. As a result, it is possible to create a machine learning model with high estimation accuracy while suppressing excessive data transmission from the terminal devices 10 to the server 20. Therefore, according to the present embodiment, data can be efficiently collected from the terminal devices 10.

In the above embodiment, the transmission control unit 165 sets the target transmission frequency of the data per unit time from the terminal device 10 to the server 20 higher in the condition where the occurrence probability of the low occurrence class is relatively higher than in the condition where the occurrence probability of the low occurrence class is relatively lower. However, in the condition where the occurrence probability of the low occurrence class is relatively higher, the transmission of data to the server 20 may be controlled in any manner as long as the decimation amount of data to be transmitted from the terminal device 10 to the server 20 can be reduced and thus the amount of data to be transmitted from the terminal device 10 to the server 20 per unit time can be increased, compared with the condition where the occurrence probability of the low occurrence class is relatively lower. For example, the transmission control unit 165 may control the data transmission rate instead of the data transmission frequency. Therefore, the target transmission amount setting unit 232 sets the target transmission amount per unit time for each condition so that the target transmission amount of data per unit time from the terminal device 10 to the server 20 is larger in the condition in which the occurrence probability of the low occurrence class is relatively higher than in the condition in which the occurrence probability of the low occurrence class is relatively lower.

In the above embodiment, a machine learning model for estimating whether or not a patient suffers from heat stroke is used. However, any model may be used as the machine learning model as long as the model estimates the value of an arbitrary output parameter based on data acquired by a data acquisition device such as the terminal device 10. Therefore, as the machine learning model, for example, a model for estimating the occurrence and position of an abnormal person (suspicious person, a person who is likely to have suffered from a sudden illness, or the like) in the image data based on the image data acquired by the surveillance camera may be used.

In addition, in the above embodiment, the machine learning model is used in the terminal device 10. However, the machine learning model may be used in the server 20. In this case, the data acquisition unit 161, the model execution unit 162, and the like are provided in the server 20. The data acquisition unit 161 of the server 20 acquires data detected by the sensor 12 of the terminal device 10 from the terminal device 10 via the communication network 4. The model execution unit of the server 20 inputs the data received from the terminal device 10 as an input parameter to the machine learning model, calculates the value of the output parameter, and transmits the calculated value of the output parameter to the terminal device 10. In this case, the transmission control unit 165 may control the transmission from the terminal device 10 not only for the data used for the training of the machine learning model but also for the data used for the execution of the machine learning model.

In addition, in the above embodiment, low occurrence classes having a relatively low occurrence probability as compared with other classes among all classes classified by the machine learning model are specified in advance. However, the low occurrence class may be specified by the server 20 based on data or the like transmitted from the terminal device 10 in the past.

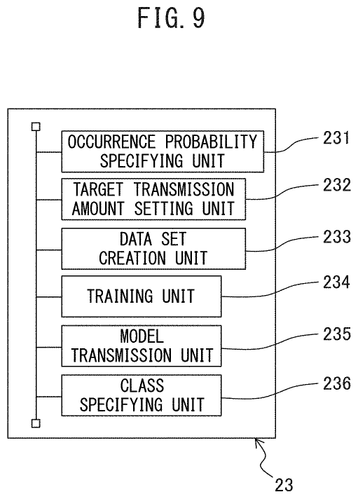

FIG. 9 is a functional block diagram, similar to FIG. 5, of the processor 23 of the server 20 according to one modification of the first embodiment. As shown in FIG. 9, the processor 23 of the present modification further includes, in addition to the functional blocks of FIG. 5, a class specifying unit 236 for specifying a low occurrence class having a relatively low occurrence probability compared to other classes among all classes classified by the machine learning model.

The class specifying unit 236 calculates the occurrence probability of all the classes classified by the machine learning model in a certain period, based on the past data transmitted by the terminal device 10. Specifically, in the present modification, for example, the low occurrence class is specified based on the number of terminal devices 10 that received data during a certain period of time and the number of terminal devices 10 (users) linked to the heat stroke suffering information. Then, the occurrence probability specifying unit 231 specifies the occurrence probability of the low occurrence class specified in this manner for each condition.

In addition, in the above embodiment, the condition specification unit 164 and the transmission control unit 165 are provided in the terminal device 10. Therefore, the specification of the current condition and the setting of the target transmission frequency are performed in the terminal device 10. However, the condition specification unit 164 and the transmission control unit 165 may be provided in the server 20.

In this case, the data required to specify the current condition of the terminal device 10 is periodically transmitted from the terminal device 10 to the server 20. The condition specification unit 164 of the server 20 specifies the current condition of the terminal device 10, based on the data transmitted from the terminal device 10 in this manner. Alternatively, the condition specification unit 164 of the server 20 may specify the current condition of the terminal device 10, based on the data transmitted from the terminal device 10 in the past in step S17 of FIG. 8 described above. Then, the transmission control unit 165 of the server 20 sets the target transmission frequency in the terminal device 10, based on the current condition specified by the condition specification unit 164. Thereafter, the transmission control unit 165 transmits the set target transmission frequency to the terminal device 10. The data transmission unit 166 of the terminal device 10 transmits data to the server 20 in accordance with the target transmission frequency thus transmitted.

### Second Embodiment

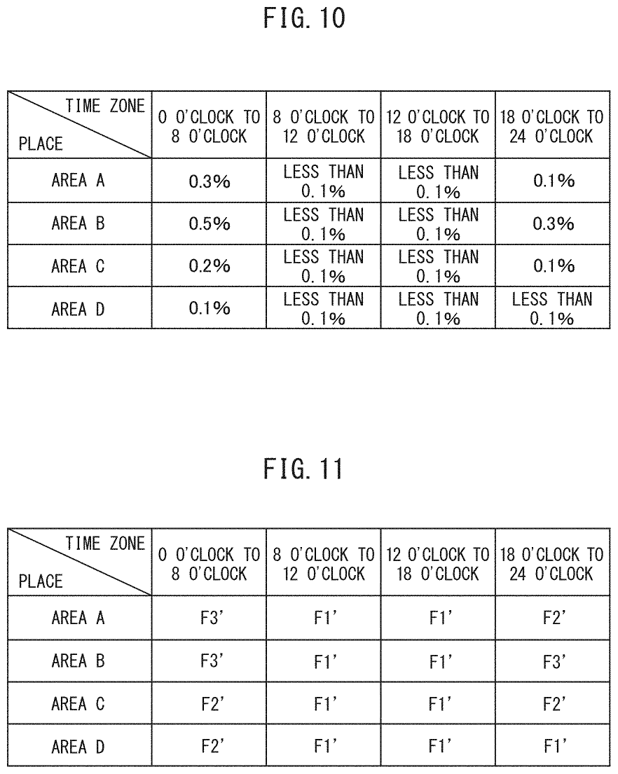

Next, the machine learning system 1 according to the second embodiment will be described with reference to FIGS. 10 to 11. The following description focuses on points different from the machine learning system according to the first embodiment. In the present embodiment, the server 20 performs training of a plurality of machine learning models having different input parameters at least in part. Thus, the server collects the data to train such plurality of machine learning models. In the following description, the server 20 performs training of a first machine learning model outputting whether or not the user suffers from heat stroke, and a second machine learning model outputting whether or not an abnormal person occurs, is explained as an example.

Meanwhile, when the server 20 trains a plurality of machine learning models, data for training all the machine learning models is transmitted to the server 20. Thus, a large amount of data is transmitted to the server 20 and a large amount of data is stored in the storage device 22 of the server 20. Therefore, a storage device 22 with very large storage capacity is required.

On the other hand, the training of the machine learning model basically increases the estimation accuracy by the machine learning model. Therefore, from the viewpoint of increasing the estimation accuracy by the machine learning model, it is preferable to collect a lot of data on the machine learning model.

Here, the necessity of the machine learning model differs for each machine learning model. In general, machine learning models for human health are more necessary than other machine learning models. In the present embodiment, the necessity of the first machine learning model for outputting whether or not a person suffers from heat stroke is higher than the necessity of the second machine learning model for outputting the presence or absence of an abnormal person. Therefore, in the present embodiment, the first machine learning model relating to human health has a larger amount of data transmitted from the terminal device 10 per unit time under the condition that the occurrence probability of the low occurrence class is the same as that of the second machine learning model not relating to human health.

FIG. 10 is a diagram showing the occurrence probability of an abnormal person under each condition. In particular, FIG. 10 shows the occurrence probability of an abnormal person for each condition defined by a time zone and a place (area). As can be seen from FIG. 10, the occurrence probability of an abnormal person is low under any condition. Therefore, it can be said that the class representing the occurrence of the abnormal person is a low occurrence class having a relatively low occurrence probability. On the other hand, it can be said that the class indicating that the abnormal person does not occur is a class having a relatively high occurrence probability.

Therefore, even in this embodiment, as in the example shown in FIG. 7, in accordance with the occurrence probability of the low occurrence class in each condition, the target transmission frequency for each condition is set. FIG. 11 is an example of setting the target transmission frequency for each condition when the occurrence probability of the low occurrence class in each condition is the probability shown in FIG. 6. As shown in FIG. 11, the target transmission amount setting unit 232 for setting the target transmission frequency sets the target transmission frequency to F1′ under the condition that the occurrence probability of occurrence of an abnormal person is less than 0.1%. The target transmission amount setting unit 232 sets the target transmission frequency to F2′ higher than F1′ under the condition that the occurrence probability of an abnormal person is 0.1% or more and less than 0.3%. Further, the target transmission amount setting unit 232 sets the target transmission frequency to F3′ higher than F2′ under the condition that the occurrence probability of an abnormal person is 0.3% or more.

In particular, in the present embodiment, the target transmission frequency of the second machine learning model for outputting the presence or absence of an abnormal person is set lower than that of the first machine learning model for human health. Therefore, in the present embodiment, the target transmission frequency F1′ for the second machine learning model is set lower than the corresponding target transmission frequency F1 for the first machine learning model. The target transmission frequency F2′ for the second machine learning model is set lower than the corresponding target transmission frequency F2 for the first machine learning model. Similarly, in the present embodiment, the target transmission frequency F3′ for the second machine learning model is set lower than the corresponding target transmission frequency F3 for the first machine learning model.

As described above, in the present embodiment, with respect to the machine learning model relating to human health among the machine learning models, the target transmission amount setting unit 232 sets the target transmission amount per unit time so that the target transmission amount per unit time is larger in the condition in which the occurrence probability of the low occurrence class is the same, as compared with the machine learning model not related to human health. As a result, the machine learning model relating to human health can be trained at an early stage, and the estimation accuracy can be enhanced at an early stage.

In the present embodiment, training of two machine learning models, a first machine learning model and a second machine learning model, is performed by the server 20. However, even in the case where training of three or more machine learning models is performed by the server 20, as in the present embodiment, it is possible to change the target transmission amount based on whether or not it relates to human health.

While preferred embodiments of the present disclosure have been described above, the present disclosure is not limited to these embodiments, and various modifications and changes may be made within the scope of the appended claims.

1. A data collection system for collecting data, for training of a machine learning model for classifying into a plurality of classes, from a data acquisition device to a data collection device, the data collection system including a processor,
the processor being configured to:
specify a occurrence probability of a low occurrence class having a relatively lower occurrence probability compared to other classes of all classes classified by the machine learning model, for each condition when data is acquired by the data acquisition device;
set a target transmission amount per unit time from the data acquisition device to the data collection device, for each condition;
specify a current condition under which data is acquired by the data acquisition device; and
transmit data from the data acquisition device to the data collection device, in accordance with a target transmission amount corresponding to the specified current condition; wherein
the processor sets the target transmission amount such that an amount of data transmission per unit time from the data acquisition device to the data collection device is larger in a condition having a relatively higher occurrence probability of the low occurrence class, compared to a condition having a relatively lower occurrence probability of the low occurrence class.

2. The data collection system according to claim 1, wherein the processor sets the target transmission amount per unit time so that the higher the occurrence probability of the low occurrence class, the greater the amount of data transmission per unit time from the data acquisition device to the data collection device.

3. The data collection system according to claim 1, wherein
the data collection system collects data for training a plurality of machine learning models having at least partially different input parameters, and
the processor sets the target transmission amount per unit time such that the target transmission amount per unit time is larger, in a condition in which the occurrence probability of the low occurrence class is the same, for a machine learning model related to human health among the machine learning models, compared to for a machine learning model not related to human health.

4. The data collection system according to claim 1, wherein the processor is configured to specify the low occurrence class having a relatively lower occurrence probability among all classes classified by the machine learning model, as compared with other classes.

5. The data collection system according to claim 1, wherein:
the data collection device comprises the processor configured to specify the occurrence probability and set the target transmission amount, and the data acquisition device comprises the processor configured to specify the current condition and transmit the data to the data collection device.

6. A data collection method for collecting data, for training of a machine learning model for classifying into a plurality of classes, from a data acquisition device to a data collection device, the method comprising:
specifying, by a processor, an occurrence probability of a low occurrence class having a relatively lower occurrence probability compared to other classes among all classes classified by the machine learning model, for each condition when data is acquired by the data acquisition device;
setting, by the processor, a target transmission amount per unit time from the data acquisition device to the data collection device for each condition so that an amount of data transmission per unit time from the data acquisition device to the data collection device is larger in a condition where the occurrence probability of the low occurrence class is relatively higher, compared to a condition where the occurrence probability of the low occurrence class is relatively lower;
specifying, by the processor, a current condition under which data is acquired by the data acquisition device; and
transmitting data from the data acquisition device to the data collection device, in accordance with a target transmission amount corresponding to the specified current condition.

7. A data collection device for collecting data, for training of a machine learning model for classifying into a plurality of classes, from a data acquisition device, the data collection device including a processor,
the processor is configured to:
specify an occurrence probability of a low occurrence class having a relatively lower occurrence probability compared to other classes of all classes classified by the machine learning model, for each condition when data is acquired by the data acquisition device; and
set a target transmission amount per unit time from the data acquisition device to the data collection device, for each condition, wherein
the processor is configured to set a target transmission amount such that an amount of data transmission per unit time from the data acquisition device is larger in a condition having a relatively higher occurrence probability of the low occurrence class, compared to a condition having a relatively lower occurrence probability of the low occurrence class, and
the processor is configured to transmit the target transmission amount per unit time for each condition set, to the data acquisition device.
